(19) United States
(12) Patent Application Publication
(10) Pub. No.: US 2008/0146330 A1
(43) Pub. Date: Jun. 19, 2008

(54) Gaming Machine with Bonus Game

(75) Inventor: Kazumasa YOSHIZAWA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORPORATION, Tokyo (JP)

(21) Appl. No.: 11/956,776

(22) Filed: Dec. 14, 2007

(30) Foreign Application Priority Data
Dec. 15, 2006 (JP) 2006-339039

(51) Int. Cl. A63F 13/00

(52) U.S. Cl. 463/31

(57) ABSTRACT

The present invention provides a new gaming machine configured with a non-traditional bonus game by improving entertainments in the bonus game. In a liquid crystal panel (5B) after moving to a free game, a title image of the free game is firstly displayed. Then a preset number of times performance for reporting the preset number of times which is determined immediately after moving to the free game is performed. Further, the preset multiple performance for reporting the preset multiple which is determined immediately after moving to the free game is performed. During these performances, it takes time to display scenes in which a character related to the base game, i.e. the “FRANKENSTEIN”, selects and reports the preset number of times and the preset multiple. And then, a display status before the free game is returned.

### FIELD OF THE INVENTION

The present invention relates to a gaming machine with a bonus game.

### BACKGROUND

According to a game in a conventional slot machine, a plurality of reels with a plurality of symbols are used no matter it is a mechanical slot/video slot machine. The game begins according to a number of bets preset by a player. When the slot machine detects the player has set the number of bets, it rotates and displays the reels to variably display a plurality of symbols on the reels, and then stops the variable display of the reels so that symbols determined by an internal filtration are stopped and displayed. A plurality of pay lines that cross some symbols displayed on respective reels are set and a winning is determined according to a combination of symbols displayed along the pay lines. As the determination result of winning, an allotment is paid according to the combination of symbols determined to the winning combination and according to the number of bets.

In slot machines located in large amount in casinos, when a winning of a base game is determined, it is also needed to determine a selection of a bonus game. For example, when a result of the base game is that the combination of symbols stopped and displayed is the same as a preset one, a movement from the base game to the bonus game is carried out. In the bonus game, in most cases, a game advantageous to players is played without the number of bets reset by the players. Therefore, by playing bonus games different with the base game, the player becomes interested in the slot machine.

There are many forms adopted for the bonus game, but as a representative bonus game, as described in patent document 1, its form is basically the same with the base game, wherein a plurality of symbols are variably displayed and stopped to be displayed, the player will not re-bet but a preset number of times of the bonus game is continued automatically by increasing the allotment by a preset multiple.

[patent document 1] The Australia patent application specification determined by a priority No. PQ6296 filed on Mar. 17, 2000.

### SUMMARY OF THE INVENTION

However, according to the slot machine described in patent document 1, the bonus game is executed with a preset number of times and a preset multiple, only repeats in a form the same as the base game with the preset number of times and the preset multiples and does not appeal a preset number of times performance or a preset multiple performance. Thus, the flow of games is comparatively monotonous for the player. Therefore, players who begin the bonus game and seek for excitation cannot be satisfied.

An objective of the present invention is to provide a new gaming machine with a non-traditional bonus game by improving entertainments in the bonus game.

In order to achieve the objective, a gaming machine according to a first aspect of the present invention is provided and includes a display displaying a plurality of symbols and a control apparatus programmed by operating the display according to the following modes (a)˜(e). The control apparatus (a) executes a base game, wherein a process from a variable display of the symbols on the display to a stop and display of symbols is taken as a unit game; (b) executes a bonus game, in which the unit game is executed for a preset number of times; (c) selects the preset number of times from a set of preset number of times before executing the unit game in the bonus game; (d) reports the selection result through the display; and (e) ends the bonus game when the unit game has been executed for the preset number of times.

In the first aspect, the slot machine with the above structure executes a base game, wherein a process from a variable display of the symbols on the display to a stop and display of symbols is taken as a unit game; executes a bonus game, in which the unit game is executed for a preset number of times; selects the preset number of times from a set of preset number of times before the unit game in the bonus game is executed; reports the selection result through the display; and ends the bonus game when the unit game has been executed for the preset number of times. Therefore, the player can have the excitation to select the number of times to repeat the unit game from the set of preset number of times. In addition, the excitation of the player can be sustained until the display reported the selection result. When the preset number of times to repeat the unit game is fewer, the payout rate may be reduced but when selecting the preset number of times from the set of preset number of times in a next bonus game, the payout rate can be easily adjusted.

In a second aspect of the present invention, as the gaming machine of the first aspect, when executing the operation in the mode (d), the control apparatus (1) displays a character related to the base game and the set of preset number of times on the display; and, (2) executes on the display a performance in which the character selects the preset number of times from the set of preset number of times.

In the second aspect, when the selection result is reported through the display, the slot machine with the above structure displays a character related to the base game and the set of preset number of times on the display; and executes on the display a performance in which the character selects the preset number of times from the set of preset number of times. Therefore the player is interested in the performance and the excitation of the player can be further increased.

In addition, a gaming machine according to a third aspect of the present invention is provided and includes a display displaying a plurality of symbols and a control apparatus programmed by operating the display according to the following modes (a)˜(e). The control apparatus (a) executes a base game, wherein a process from a variable display of the symbols on the display to a stop and display of symbols is taken as a unit game; (b) executes a bonus game, in which the unit game is executed for a preset number of times and an allotment based on the execution result is increased by a preset multiple; (c) selects the preset multiple from a set of the preset multiple before executing the unit game in the bonus game; (d) reports the selection result through the display; and (e) ends the bonus game when the unit game has been executed for the preset number of times with the preset multiple.

In the third aspect, the slot machine with the above structure executes a base game, wherein a process from a variable display of the symbols on the display to a stop and display of symbols is taken as a unit game; executes a bonus game, in which the unit game is executed for a preset number of times and an allotment based on the execution result is increased by a preset multiple; selects the preset multiple from a set of the preset multiple before executing the unit game in the bonus game; reports the selection result through the display; and ends the bonus game when the unit game has been executed for the preset number of times with the preset multiple. Therefore, a player can have the excitation to select, from the set of preset multiples, the preset multiple by which the allotment is increased. In addition, the excitation of the player can be sustained until the display reported the selection result. When the preset multiple to increase the allotment is fewer, the payout rate may be reduced but when selecting the preset multiple from the set of preset multiples in a next bonus game the payout rate can be easily adjusted.

In a fourth aspect of the present invention, as the gaming machine of the third aspect, when executing the operation in the mode (d), the control apparatus (1) displays a character related to the base game and the set of preset multiples on the display; and (2) executes on the display a performance in which the character selects the preset multiple from the set of preset multiple.

In the fourth aspect, when the selection result is reported through the display, the slot machine with the above structure displays a character related to the base game and the set of preset multiples on the display; and executes on the display a performance in which the character selects the preset multiple from the set of preset multiples. Therefore the player is interested in the performance and the excitation of the player can be further increased.

In addition, a gaming machine according to a fifth aspect of the present invention is provided and includes a display displaying a plurality of symbols and a control apparatus programmed by operating the display according to the following modes (a)˜(e). The control apparatus (a) executes a base game, wherein a process from a variable display of the symbols on the display to a stop and display of symbols is taken as a unit game; (b) executes a bonus game, in which the unit game is executed for a preset number of times and an allotment based on the execution result is increased by a preset multiple; (c) performs a first selection to select the preset number of times from a set of preset number of times and performs a second selection to select the preset multiple from a set of the preset multiple before executing the unit game in the bonus game; (d) reports the selection results of the first selection and the second selection through the display; and (e) ends the bonus game when the unit game has been executed for the preset number of times with the preset multiple.

In the fifth aspect, the slot machine with the above structure executes a base game, wherein a process from a variable display of the symbols on the display to a stop and display of symbols is taken as a unit game; executes a bonus game, in which the unit game is executed for a preset number of times and an allotment based on the execution result is increased by a preset multiple; performs a first selection to select the preset number of times from a set of preset number of times and performs a second selection to select the preset multiple from a set of the preset multiple before executing the unit game in the bonus game; reports the selection results of the first selection and the second selection through the display; and ends the bonus game when the unit game has been executed for the preset number of times with the preset multiple. Therefore, a player can have the excitation to select the preset number of times to repeat the unit game from the set of preset number of times and to select, from the list of the preset multiple, the preset multiple by which the allotment is increased. In addition, the excitation of the player can be sustained until the display reported the selection result. When the preset number of times to repeat the unit game is fewer or when the preset multiple to increase the allotment is fewer, the payout rate may be reduced but when selecting the preset number of times from the set of preset number of times or selecting the preset multiple from the set of preset multiples in a next bonus game, the payout rate can be easily adjusted.

In a sixth aspect of the present invention, as the gaming machine of the fifth aspect, when executing the operation in the mode (d), the control apparatus (1) display a character related to the base game, the set of preset number of times and the set of preset multiples on the display; and (2) executes on the display a first performance in which the character selects the preset number of times from the set of preset number of times and a second performance in which the character selects the preset multiple from the set of preset multiples.

In the sixth aspect, when the selection result is reported through the display, the slot machine with the above structure display a character related to the base game, the set of preset number of times and the set of preset multiples on the display; and executes on the display a first performance in which the character selects the preset number of times from the set of preset number of times and a second performance in which the character selects the preset multiple from the set of preset multiples. Therefore the player is interested in the performance and the excitation of the player can be further increased.

In a seventh aspect of the present invention, as the gaming machine of the sixth aspect, when executing the operation in the mode (d) (2), the control apparatus executes the second performance on the display after the first performance is executed on the display.

In the seventh aspect, the slot machine with the above structure executes the second performance on the display after the first performance is executed on the display. Therefore the player is interested in the performance and the excitation of the player can be further sustained.

In a eighth aspect of the present invention, as the gaming machine of the sixth aspect, when executing the operation in the mode (d) (2), the control apparatus executes the first performance on the display after the second performance is executed on the display.

In the eighth aspect, the slot machine with the above structure executes the first performance on the display after the second performance is executed on the display. Therefore the player is interested in the performance and the excitation of the player can be further sustained.

According to the gaming machine of the present invention, players may have the excitation when moving to the bonus game so that the entertainments in the bonus game are improved and a non-traditional new gaming machine is provided.

### BRIEF DESCRIPTION OF THE DRAWINGS

FIG. 1 is a diagram showing features of a gaming machine according to an embodiment of the present invention;

FIG. 2 is a solid diagram showing the appearance of the gaming machine;

FIG. 3 is a schematic diagram showing symbol columns drawn on reel strips of respective reels;

FIG. 4 is a block diagram showing an internal structure of the gaming machine as a whole;

FIG. 5 is a block diagram showing an internal structure of the sub-control base board;

FIG. 6 is an allotment table showing winning combinations and allotments of respective winning combinations when performing a base game or a free game with reels;

FIG. 7 is a diagram showing an example of an image displayed on a liquid crystal panel;

FIG. 8 is a diagram showing an example of an image displayed on a liquid crystal panel;

FIG. 9 is a diagram showing an example of an image displayed on a liquid crystal panel;

FIG. 10 is a diagram showing an example of an image displayed on a liquid crystal panel;

FIG. 11 is a flow chart of a main control program;

FIG. 12 is a flow chart of a main game processing program; and

FIG. 13 is a flow chart of a free game processing program.

### REFERENCE SIGN EXPLANATION

1 gaming machine; 5B liquid crystal panel; 31 microcomputer; 32 main CPU; 33 ROM; 34 RAM; 72 sub-control base board; L pay line; R1, R2, R3 reel; W1, W2, W3 display window

### DETAILED DESCRIPTION OF THE INVENTION

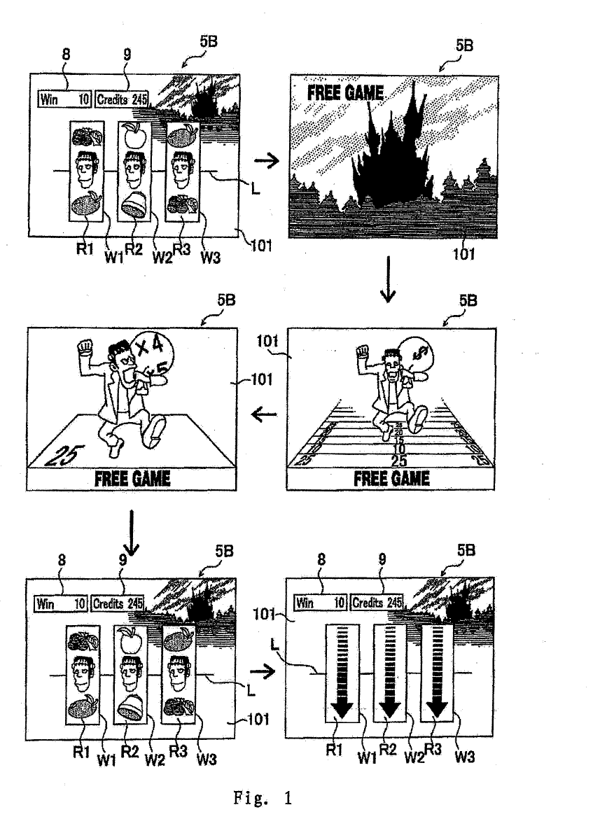

Embodiments of the present invention will be illustrated with reference to accompanied drawings. FIG. 1 is a diagram showing features of a gaming machine according to an embodiment of the present invention. Games that are performed in the gaming machine according to this embodiment consist of two game modes: base game and bonus game.

In the base game, as shown in an upper-left of FIG. 1, 3 symbols on each of 3 reels R1, R2 and R3 are configured on a display panel 5B composed by a commonly known transparent liquid crystal panel through 3 transparent display windows W1, W2 and W3 respectively. In addition, a pay line that horizontally crosses 3 display windows W1, W2 and W3 is displayed on the liquid crystal panel 5B. This pay line defines a symbol combination. A payout point display portion 8 and a credit point display portion 9 are disposed on the liquid crystal panel 5B. In addition, a touch panel 101 is disposed in front of the liquid crystal panel 5B.

On the other hand, various winning combinations are predetermined by respective symbol combinations. 3 symbols are reconfigured in respective display windows W1, W2 and W3 according to a rotation and stop of respective reels R1, R2 and R3. When a symbol combination composed by 3 symbols reconfigured on the pay line L matches some winning combination, an allotment corresponding to the winning combination is displayed in the payout point display portion 8. A unit game is thus formed. In addition, when the unit game ends, allotments displayed in the payout point display portion 8 are added and the result is displayed in the credit point display portion 9. The base game is the so-called slot game.

When the symbol combination consisting of 3 symbols reconfigured on the pay line L, as shown in the upper-left of FIG. 1, is a combination of 3 “FRANKENSTEIN” symbols (a bonus game trigger), a predetermined allotment is displayed in the payout point display portion 8 and the game moves to one of the bonus games, i.e. the free game. In the free game, the unit game of the base game is repeated for the preset number of times. Meanwhile, an allotment obtained in each unit game is increased by multiplying a corresponding preset multiple and then the allotments for respective unit games are added to display in the payout point display portion 8. In addition, the preset number of times and the preset multiple are immediately decided when moving to the free game.

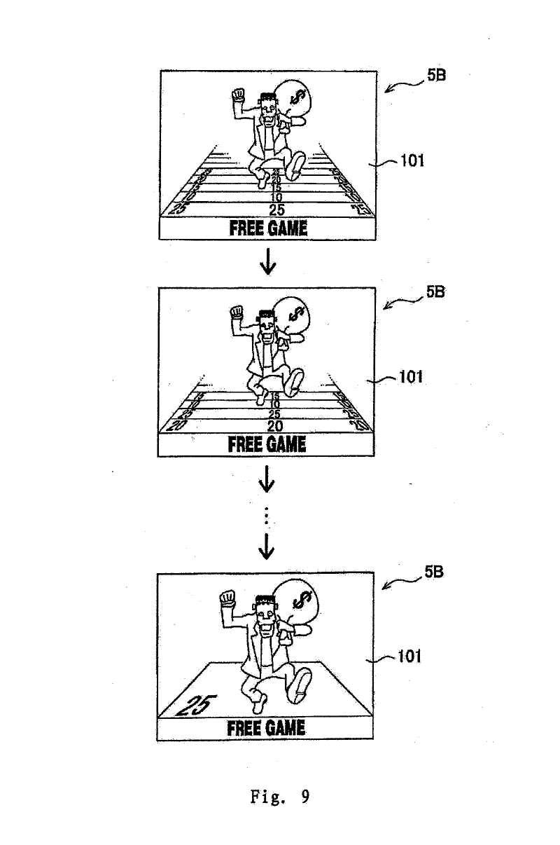

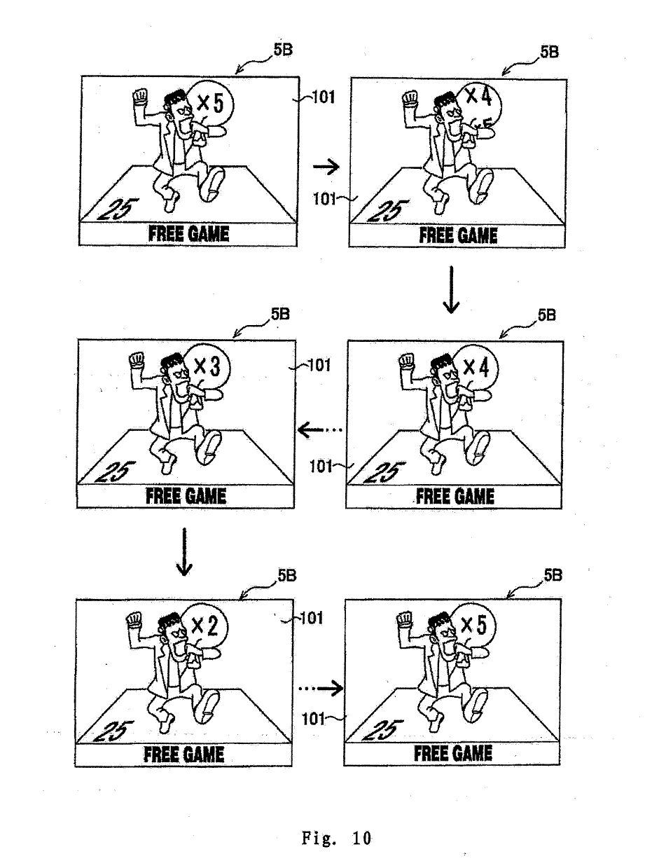

When moving to the free game, as shown in the upper-right of FIG. 1, a title image of the free game is firstly displayed on the liquid crystal panel 5B. At this time, the pay line L disappears from the liquid crystal panel 5B. In addition, three display windows W1, W2 and W3 in the crystal display panel 5B become opaque. Therefore, the player cannot see reels R1, R2 and R3. In addition, for simplicity of description, the payout point display portion 8 and the credit point display portion 9 in the liquid crystal panel 5B displayed in the upper-right of FIG. 1 are omitted, so are the display panels 5B displayed in the middle of FIG. 1. Each liquid crystal panel 5B displayed in FIG. 9 and FIG. 10 is the same.

And then, as shown in the mid-right of FIG. 1, a performance for reporting the preset number of times which is decided immediately after moving to the free game (hereinafter referred as “preset number of times performance”) is carried out on the liquid crystal panel 5B. In the preset number of times performance, in a long corridor along which multiple rectangle areas representing values of preset number of times “25”, “20”, “15”, “10” roll vertically, the same character constituting the symbol of bonus game trigger in the base game, i.e. “FRANKENSTEIN” escapes and only the value of the preset number of times represented in the rectangle area where the “FRANKENSTEIN” stops is amplified and displayed (refer to the mid-left of FIG. 1). And this shows the preset number of times determined immediately when moving to the free game.

As shown in the mid-left of FIG. 1, a performance for reporting the preset multiple which is decided immediately after moving to the free game (hereinafter referred as “preset multiple performance”) is carried out on the liquid crystal panel 5B. In the preset multiple performance, in the bag carried by the “FRANKENSTEIN”, an expression indicating a preset multiple such as “×5”, “×4”, “×3”, “×2” rotates and then one expression indicating only one preset multiple is stopped and displayed. And this shows the preset multiple immediately decided after moving to the free game.

And then, in the liquid crystal panel 5B, as shown in the lower-left of FIG. 1, a display status before moving to the free game is displayed and as shown in the lower-right of FIG. 1, the first unit game constituting the free game begins by rotating reels R1, R2 and R3.

A specific embodiment of the present invention will be described in detail with reference to the accompanied drawings.

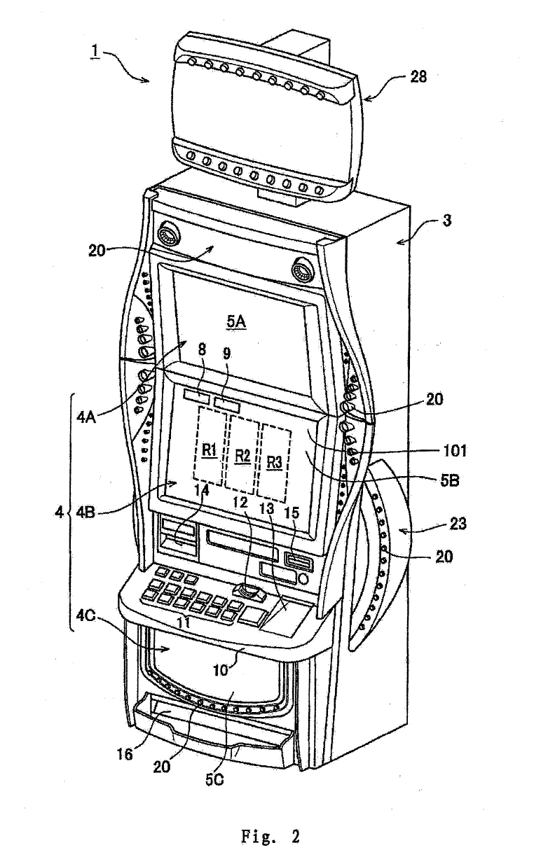

The overall structure of the gaming machine 1 according to the embodiment is described with reference to FIG. 2. FIG. 2 is a solid diagram showing the appearance of the gaming machine 1.

As shown in FIG. 2, the gaming machine 1 is an upright slot machine in casinos such as a playground and has a case 3 containing electronic or mechanical components for performing a predetermined form of game. Different display portions 4A˜4C (upper display portion 4A, middle variable display portion 4B and lower display portion 4C) are disposed in the front of the lengthwise case, as a display portion 4 for displaying information related to the game. The upper display portion 4A has a liquid crystal panel 5A configured on the upper to the middle variable display portion 4B and displays performance images, introduction of game contents, rules of game or the like through the liquid crystal panel 5A. The lower display portion 4C is configured on the lower to the variable display portion 4B and has a plastic panel 5C with a printed image, which is illuminated by a backlight.

The variable display portion 4B for displaying an implementation status of the game has a transparent liquid crystal panel 5B fixed on a front door of the case 3. The player may see from outside symbols on respective reels R1, R2 and R3 configured in the case 3 through the liquid crystal panel 5B. In the variable display portion 4B, a pay line horizontally crossing areas corresponding to respective reels R1, R2 and R3 is displayed on the liquid crystal panel 5B. In addition, on the upper of the variable display portion 4B, the payout point display portion 8 and the credit point display portion 9 are disposed on the liquid crystal panel 5B. The upper portion of the middle variable display portion 4B inclines backward so that the player may play the game comfortably.

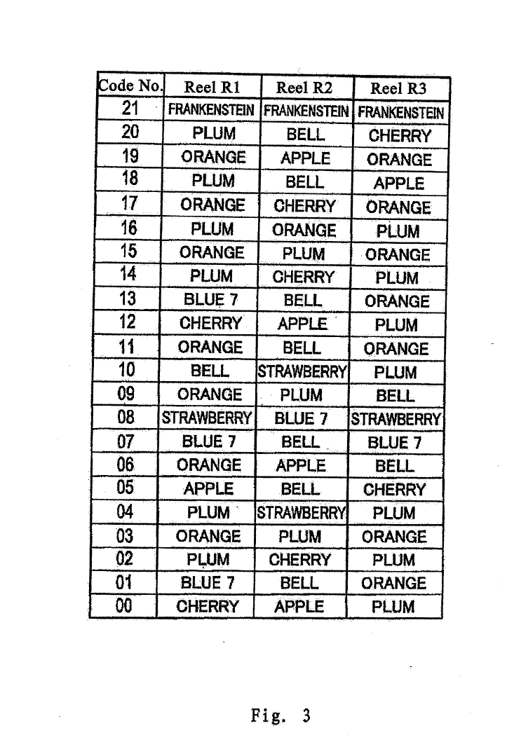

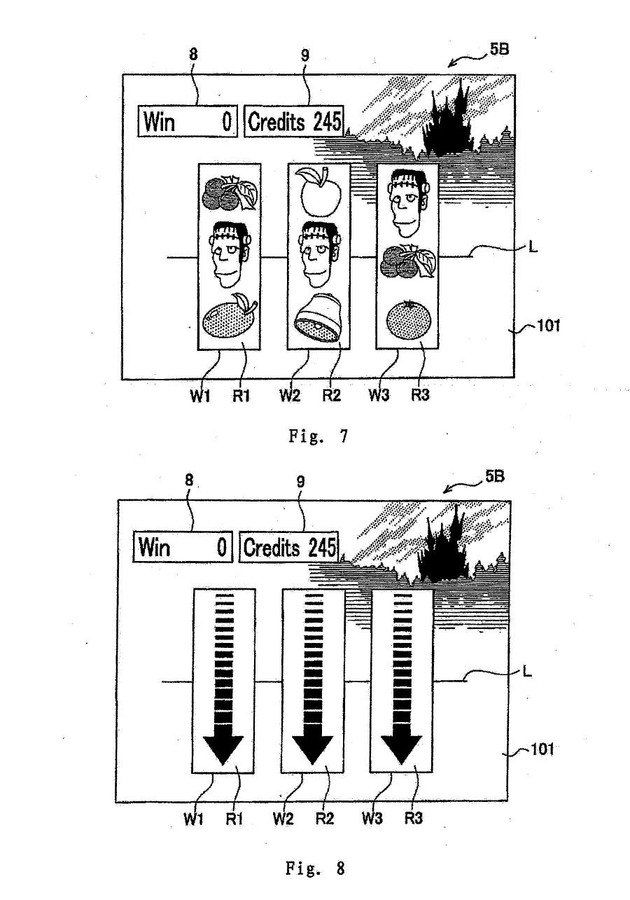

Images related to the base game displayed on the liquid crystal panel 5B are illustrated. FIG. 7 and FIG. 8 describe examples of images showing contents displayed on the liquid crystal panel 5B. During the base game, display windows W1, W2 and W3 on the liquid crystal panel 5B become transparent and the player may see symbols drawn on the reel strips of reels R1, R2 and R3, as shown in FIG. 7 and FIG. 8. FIG. 7 shows a status that symbols on the reel strips of the reels R1, R2 and R3 are configured or reconfigured through the display windows W1, W2 and W3 on the liquid crystal panel 5B, and FIG. 8 shows a status that symbols on the reel strips of the reels R1, R2 and R3 are rotated through the display windows W1, W2 and W3 on the liquid crystal panel 5B. In addition, symbol columns constituted by 22 symbols are drawn on the reel strips of reels R1, R2 and R3 respectively (refer to FIG. 3).

In addition, the touch panel 101 is disposed in front of the liquid crystal panel 5B and the player may operate the touch panel 101 to input various instructions.

The payout point display portion 8 and the credit point display portion 9 are disposed on the liquid crystal panel 5B. The allotment obtained by the player in the base game (slot game) is displayed in the payout point display portion 8 and the current credit point owned by the player is displayed in the credit point display portion 9. In addition, the allotment obtained by the player in the free game is also displayed in the payout point display portion 8.

Therefore, in the liquid crystal panel 5B during the base game, three display windows W1, W2 and W3 become transparent and three symbols respectively drawn on reels R1, R2 and R3 are configured through respective display windows W1, W2 and W3 respectively. In addition, in the liquid crystal panel 5B during the base game, as shown in FIG. 7 and FIG. 8, a pay line L horizontally crossing the three display windows W1, W2 and W3 is displayed. The pay line L specifies a combination according to symbols.

On the other hand, on the liquid crystal panel 5B immediately after moving from the base game to the free game, the pay line disappears and at the same time the display windows W1, W2 and W3 become opaque therefore the player cannot see symbols drawn on reel strips of reels R1, R2 and R3. And then, as shown in the upper-right of FIG. 1, the title image of the free game is displayed on the liquid crystal panel 5B. As shown in the mid-right of FIG. 1, the preset number of times performance is carried out on the liquid crystal panel 5B and then as shown in the mid-left of FIG. 1, the preset multiple performance is carried out.

Images related to the preset number of times performance and the preset multiple performance on the liquid crystal panel 5B after moving to the free game are illustrated. FIG. 9 and FIG. 10 are examples of images showing contents displayed on the liquid crystal panel 5B.

Firstly, during the preset number of times performance immediately carried out on the liquid crystal panel 5B after moving to the free game, as shown in the upper and middle portions of FIG. 9, in the long corridor along which the “FRANKENSTEIN” carrying the bag escapes, multiple rectangle areas representing values of preset number of times “25”, “20”, “15”, “10” roll slowly in the vertical direction in a mode visible to the player. Values of preset number of times roll vertically along the long corridor in the order of “25”→“20”→“15”→“10”→“25”→ . . . . And then, as shown in the lower portion of FIG. 9, only the value of the preset number of times represented in the rectangle area where the “FRANKENSTEIN” stops is amplified and displayed in the long corridor. And this shows the preset number of times decided immediately when moving to the free game. Thus after a period, the preset number of times decided immediately when moving to the free game is displayed.

On the other hand, during the preset multiple performance carried out on the liquid crystal panel 5B immediately after moving to the free game, as shown in the upper-left of FIG. 10, the expression “×5” that is one of the preset multiples is displayed in the middle of the bag carried by the “FRANKENSTEIN” and then as shown in the upper-right of FIG. 10, when the expression “×5” moves and displays from the middle to the lower portion, the expression that is one of the preset multiples moves and displays from the upper portion to the middle. As a result, the expression “×4” is displayed in the middle, as shown in the mid-right of FIG. 10. And similarly, as shown in the mid-left of FIG. 10, the expression “×3” that is one of the preset multiples is displayed in the middle and as shown in the lower left of FIG. 10, the expression “×2” that is one of the preset multiples is displayed in the middle. Thus, each expression that can be a preset multiple rolls from up to down slowly in a visible mode to the player in the bag carried by the “FRANKENSTEIN”. Expressions that can be preset multiples roll in the order of “×5”→“4”→“×3”→“×2”→“×5”→ . . . from up to down in the bag. And then, as shown in the lower right of FIG. 10, the expression that is one of the preset multiples is stopped and displayed in the middle of the bag carried by the “FRANKENSTEIN”. And this shows the preset multiple decided immediately when moving to the free game. On the liquid crystal panel 5B displayed in the lower right of FIG. 10, the expression “×5” that is the preset multiple decided immediately when moving to the free game is stopped and displayed. Thus after a period, the preset multiple decided immediately when moving to the free game is displayed.

In addition, on the liquid crystal panel 5B, when carrying out the preset number of times and preset multiple performances of the free game, the first unit game (refer to the lower right of FIG. 1) constituting the free game is started by returning to the status before the free game (refer to the lower left of FIG. 1) and by starting to rotate respective reels R1, R2 and R3. At this time, an image related to the free game is displayed on the liquid crystal panel 5B, which is the same as the image related to the base game.

Returning to FIG. 2, between the middle variable display portion 4B and the lower display portion 4C, an operation table 10 protruding forwards is disposed in front of the case 3 and in this operation table 10, different operation buttons 11 such as the BET button, COLLECT button, SPIN button, CASHOUT button are arranged as an operation portion to indicate the execution of the game. A coin insertion slot 12 and a bill insertion slot 13 are disposed on the operation table 10. A ticket printer 14 and a card reader 15 are disposed between the operation table 10 and the middle variable display portion 4B. A coin tray 16 is placed at the lowest portion of the case 3.

In addition, in the gaming machine 1 according to the present embodiment, the game media can be a coin, a paper money or corresponding electronic valuable information (credit). However, the game media can be applied in the present invention is not limited to the above and can be a medal, token, electronic money, ticket or the like.

In addition, on the case 3 of the gaming machine 1, a light emitting part 20 is configured to surround game areas including the upper display portion 4A, the middle variable display portion 4B, the lower display portion 4C and the operation table 10.

The gaming machine 1 also has a top performance apparatus 28 mounted on the case 3. The top performance apparatus 28 is of a rectangular shape and is configured substantially parallel to the liquid crystal panel 5A of the upper display portion 4A.

Symbols drawn on the strips of respective reels R1, R2 and R3 and reconfigured when rotating through respective display windows W1, W2 and W3 on the liquid crystal panel 5B during the base game and the free game are described. FIG. 3 is a schematic diagram showing symbol columns drawn on the reel strip of each of the reels R1, R2 and R3.

22 symbols are drawn on the reel strip of each of the reels R1, R2 and R3. Each symbol column is composed by a symbol combination of “FRANKENSTEIN”, “blue 7”, “bell”, “apple”, “cherry”, “strawberry”, “plum” and “orange”. The preset types of symbols are configured according to a preset sequence.

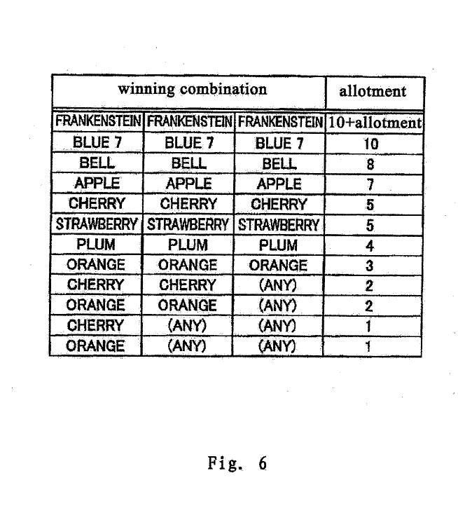

When three symbols of the “blue 7”, “bell”, “apple”, “cherry”, “strawberry”, “plum” and “orange” are reconfigured on the pay line L on the liquid crystal panel 5B, a preset allotment is paid to the player (refer to FIG. 6). In addition, even when one or two symbols of “cherry” and “orange” are reconfigured on the pay line L on the liquid crystal panel 5B, a preset allotment is paid to the player according to the number (refer to FIG. 6).

In addition, when three symbols of “FRANKENSTEIN” are reconfigured on the pay line L on the liquid crystal panel 5B, a preset allotment is paid to the player and the base game moves to the free game.

In addition, in the symbol columns in FIG. 3, code numbers are allocated in the order from up to down for respective symbol combinations.

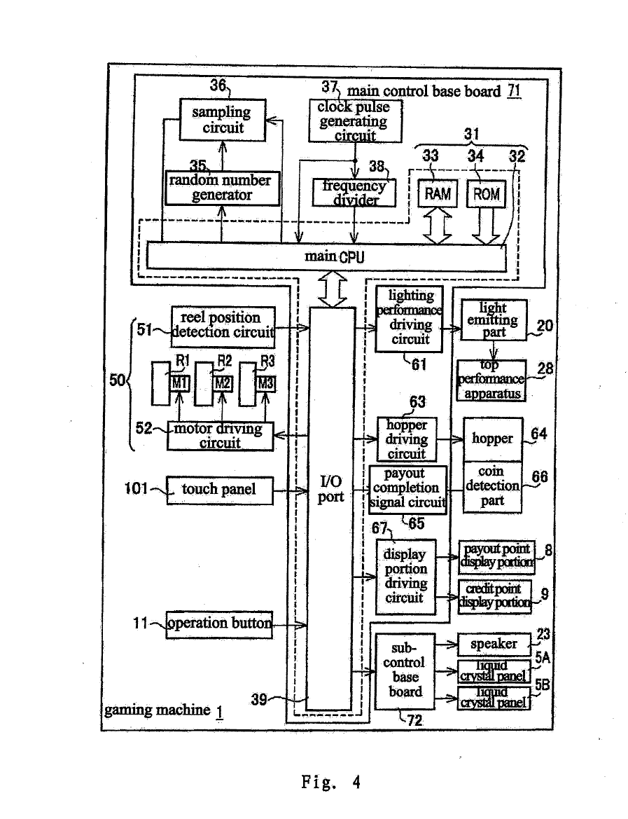

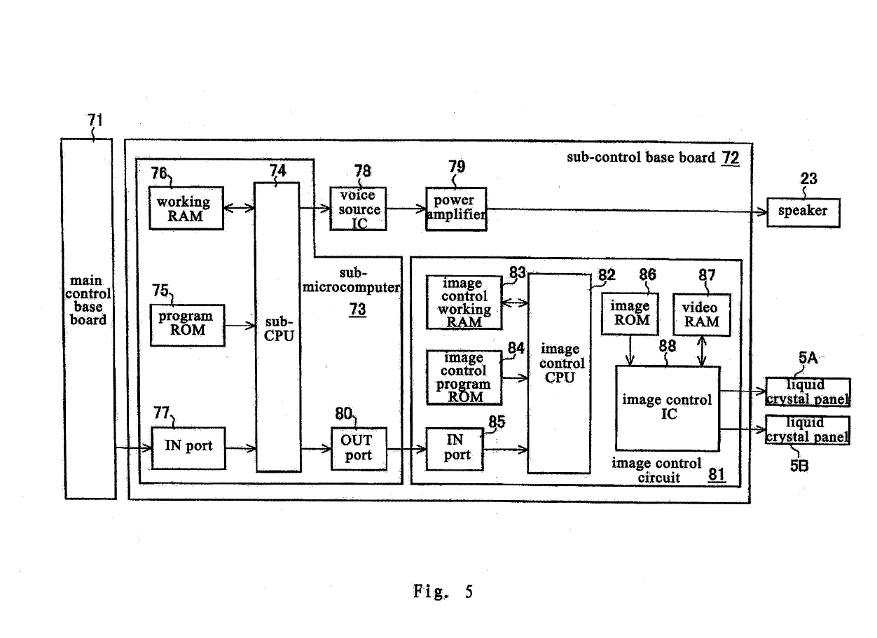

Next, the internal structure of the gaming machine 1 is illustrated with reference to FIG. 4 and FIG. 5.

FIG. 4 is a block diagram showing an internal structure of the gaming machine as a whole. As shown in FIG. 4, the gaming machine 1 has multiple components with a main control base board 71 having a micro-computer 31 as a center. The main control base board 71 has a micro-computer 31, a random number generator 35, a sampling circuit 36, a clock pulse generating circuit 37, a frequency divider 38, a lighting performance driving circuit 61, a hopper driving circuit 63, a payout completion signal circuit 65 and a display portion driving circuit 67.

The micro-computer 31 has a main CPU 32, a RAM 33 and a ROM 34. The main CPU 32 works according to programs stored in the ROM 34, performs signal input and output with other components through an I/O port 39 and control actions of the gaming machine as a whole. The RAM 33 stores data and programs used by the CPU 32 being working. For example, after the game starts the RAM 33 temporarily stores a random number value sampled by the sampling circuit 36, and stores symbol numbers and code numbers of respective reels R1, R2 and R3. In the ROM 34, programs and permanent data executed by the main CPU 32 are stored.

Especially, programs stored in the ROM 34 include a game program and a game system program (which are called game programs in the following). In addition, the following first to third lottery programs are included in the game programs.

The first lottery program is for deciding the code number of each of the reels R1, R2 and R3 corresponding to each symbol reconfigured on the pay line L on the liquid crystal panel 5B. In this lottery program, symbol weighting data corresponding to multiple payout ratios (such as 80%, 84% and 88%) respectively are included. The symbol weighting data are related to each of the reels R1, R2 and R3 and show relations between each code number and one or more random number within a value range (0-255). One or more random number corresponds to one code number according to the payout ratio and the random number is extracted by lottery so that the symbol decided according to the random number is reconfigured on the pay line L on the liquid crystal panel 5B.

The second lottery program is for deciding value of the number of times, which corresponds to the value of the preset number of times for the free game in a set of preset number of times constituted by values of “25”, “20”, “15” and “10”. In addition, in this lottery program, symbol weighting data corresponding to multiple payout ratios (such as 80%, 84% and 88%) respectively are included. The symbol weighting data show relations between each value of number of times and one or more random number within a value range (0-255), for each of values of “25”, “20”, “15” and “10” which constitute the set of preset number of times. One or more random number corresponds to one number of times according to the payout ratio and the random number is extracted by lottery so that the value decided according to the random number is the preset number of times of the free game.

The third lottery program is for deciding the number of multiple, which corresponds to the expression decided as the preset multiple for the free game in the set of preset multiples constituted by the expressions such as “×5”, “×4”, “×3”, “×2”. In addition, in this lottery program, symbol weighting data corresponding to multiple payout ratios (such as 80%, 84% and 88%) respectively are included. The symbol weighting data show relations between each number of multiple and one or more random number within a value range (0-255), for each of the expressions such as “×5”, “×4”, “×3”, “×2” which constitute the set of preset multiples. One or more random number corresponds to one number of multiple according to the payout ratio and the random number is extracted by lottery so that the expression decided according to the random number is the preset number of multiple of the free game.

The random number generator 35 works according to instructions from the main CPU 32 and generates random numbers within a certain range. The sampling circuit 36 works according to instructions from the main CPU 32 and extracts any random number from the random numbers generated by the random number generator 35 and inputs the extracted random number to the main CPU 32. The clock pulse generating circuit generates a base clock for the main CPU 32 and the frequency divider 38 frequency divides the base clock with a certain period to obtain a signal and inputs the signal to the main CPU 32.

In addition, a reel driving unit 50 is connected to the main control base board 71. The reel driving unit 50 has a reel position detection circuit 51 for detecting positions of reels R1, R2 and R3; and a motor driving circuit 52 for inputting driving signals to motors M1, M2 and M3 respectively. The motors M1, M2 and M3 rotate the reels R1, R2 and R3 respectively according to the driving signals inputted from the motor driving circuit 52 and stop them at expected positions.

In addition, a touch panel 101 is connected to the main control base board 71. This touch panel 101 is disposed in front of the liquid crystal panel 5B and is for determining a coordinate position of a place touched by the player and the place touched by the player can be determined according to the determined coordinate position information and a direction the touched position moves can be further determined. The signal corresponding to the determination can be inputted to the main CPU 32 through the I/O port 39.

In addition, the operation button 11 including a SPIN button, a COLLECT button, a BET button etc. for indicating the execution of the game is connected to the main control base board 71 and signals corresponding to pushing these buttons are inputted to the main CPU 32 through the I/O port 39.

The lighting performance driving circuit 61 outputs a performance signal to make the light emitting part 20 and the top performance apparatus 28 to perform a lighting performance. The top performance apparatus 28 is serially connected with the lighting performance driving circuit 61 via the lighting part 20.

The hopper driving circuit 63 drives the hopper 64 according to the control of the main CPU 32 and the hopper 64 performs the action of paying coins and pays the coins from the coin tray 16. The coin detection part 66 connect with the payout completion signal circuit 65 inputs data about the number of coins to the payout completion signal circuit 65 and when the number of coins reaches a set number, the payout completion signal circuit 65 inputs a payout completion signal to the main CPU 32. The coin detection part 66 counts the number of coins paid from the hopper 64 and inputs data about the counted number of coins to the payout completion signal circuit 65. The display portion driving circuit 67 controls display actions of the payout point display portion 8 and the credit point display portion 9 and etc.

A sub-control base board 72 is connected to the main control base board 71. As shown in FIG. 5, the main control base board 71 inputs commands to the sub-control base board 72 and the sub-control base board 72 performs the display control of the liquid crystal panel 5A of the upper display portion 4A and of the liquid crystal panel 5B of the variable display portion 4B and performs the voice output control of the speaker 23. The sub-control base board 72 is constructed on a circuit base board different from that on which the main control base board 71 is constructed. A microcomputer 73 (hereinafter referred as “sub-microcomputer”) is a main component of the sub-control base board 72 and has a voice source IC 78 controlling the voice from the speaker 23, a power amplifier 79 as an amplifier and an image control circuit 81 working as a display control unit of the liquid crystal panels 5A and 5B.

The sub-microcomputer 73 has a sub-CPU 74 for performing control actions according to control commands from the main control base board 71, a program ROM 75 as a storage unit, a working RAM 76, and I/O ports 77 and 80. The sub-control base board 72 doesn't have a clock pulse generating circuit, a frequency divider, a random number generator and a sampling circuit, but performs the random number sampling by action programs of the sub-CPU 74. The program ROM 75 stores a control program executed by the sub-CPU 74. The working RAM 76 is a temporary storage unit when the control program is executed by the sub-CPU 74.

The image control circuit 81 has an image control CPU 82, an image control working RAM 83, an image control program ROM 84, an image ROM 86, a video RAM 87 and an image control IC 88. The image control CPU 82 decides images to be displayed on the liquid crystal panels 5A and 5B according to parameters set by the sub-microcomputer 73 and according to an image control program stored in the image control program ROM 84.

The image control program ROM 84 stores the image control program and various selection tables related to the display on the liquid crystal panels 5A and 5B. The image control working RAM 83 is a temporary storage unit when the image control program is executed by the image control CPU 82. The image control IC 88 forms an image corresponding to the content decided by the image control CPU 82 and outputs the image to the liquid crystal panels 5A and 5B.

The image ROM 86 stores dot data for forming the image. The video RAM 87 works as a temporary storage unit when the image is formed by the image control IC 88.

Winning combinations and their allotments when the base game or free game are performed with respective reels R1, R2 and R3 used in the gaming machine 1 of the present embodiment will be illustrated with reference to FIG. 6. FIG. 6 is a table showing winning combinations and allotments of respective winning combinations when performing a base game or a free game with respective reels R1, R2 and R3.

The allotment shown in FIG. 6 is an allotment when the bet in the base game is “1”. Therefore, when the bet is “1”, the allotment shown in FIG. 6 is paid and when the bet is equal to or greater than “2”, an allotment obtained by multiplying the allotment shown in FIG. 6 by the bet is paid.

On the other hand, the allotment shown in FIG. 6 represents an allotment when the expression of the preset multiple is “×1” in the free game. Therefore, in the free game, an allotment paid to the player is obtained by multiplying the allotment shown in FIG. 6 by the preset multiple decided immediately after moving to the free game.

Therefore, when 3 symbols of “FRANKENSTEIN” are reconfigured on the pay line L on the liquid crystal panel 5B, an allotment obtained by multiplying 10 credits by the bet or the preset multiple is paid. In addition, if a bonus game trigger is selected in the base game, a free game is generated. In addition, even in the free game, the bonus game trigger can be selected and a new free game is generated in this case.

In addition, when 3 symbols of “BLUE 7” are reconfigured on the pay line L on the liquid crystal panel 5B, an allotment obtained by multiplying 10 credits by the bet or the preset multiple is paid.

In addition, when 3 symbols of “BELL” are reconfigured on the pay line L on the liquid crystal panel 5B, an allotment obtained by multiplying 8 credits by the bet or the preset multiple is paid.

Similarly, allotments for respective winning combinations shown in FIG. 6 are set. However, when a combination composed by 3 symbols reconfigured on the pay line L on the liquid crystal panel 5B is not one of the winning combinations shown in FIG. 6, this phenomenon is called a pass and no payment is done when a pass occurs.

Thus, in the gaming machine 1 of the present embodiment, the slot game as the base game and the free game as the bonus game are executed.

During the base game, the slot game is executed by reconfiguring a combination of symbols determined by respective reels R1, R2 and R3 on the pay line L on the liquid crystal panel 5B. In addition, in this slot game, some (three symbols) of columns shown in FIG. 3 which are drawn on the reel strips of respective reels R1, R2 and R3 are configured on the liquid crystal panel 5B through respective transparent display windows W1, W2 and W3 (refer to FIG. 7). When the player pushes the operation button 11 as the BET button to set the bet and then pushes down the operation button 11 as the SPIN button, each of the reels R1, R2 and R3 rotates. Therefore, symbol columns shown in FIG. 3 which are drawn on reel strips of respective reels R1, R2 and R3 rotate from up to down and display on the liquid crystal panel 5B through respective transparent display windows W1, W2 and W3 (refer to FIG. 8).

When a certain period passes, each of the reels R1, R2 and R3 automatically stops and some (three symbols) of columns shown in FIG. 3 which are drawn on the reel strips of respective reels R1, R2 and R3 are configured on the liquid crystal panel 5B through respective transparent display windows W1, W2 and W3 (refer to FIG. 7). On the other hand, when the combination of 3 symbols reconfigured on the pay line L on the liquid crystal panel 5B corresponds to a winning combination according to various preset winning combinations (refer to FIG. 6), the allotment corresponding to the winning combination is multiplied by the bet and then the result is paid to the player.

On the other hand, in the free game as the bonus game, the slot game which reconfigures a combination of symbols decided by respective reels R1, R2 and R3 on the pay line L on the liquid crystal panel 5B is repeated for the preset number of times. Similarly, in the slot game some (three symbols) of columns shown in FIG. 3 which are drawn on the reel strips of respective reels R1, R2 and R3 are configured on the liquid crystal panel 5B through respective transparent display windows W1, W2 and W3 (refer to FIG. 7). If a certain period passes, each of the reels R1, R2 and R3 automatically rotates. Therefore, symbol columns shown in FIG. 3 which are drawn on the reel strips of respective reels R1, R2 and R3 rotate from up to down and display on the liquid crystal panel 5B through respective transparent display windows W1, W2 and W3 (refer to FIG. 8), irrespectively with whether the player pushes the operation button 11 as the BET button or the SPIN button.

When a certain period passes, each of the reels R1, R2 and R3 automatically stops and some (three symbols) of columns shown in FIG. 3 which are drawn on the reel strips of respective reels R1, R2 and R3 are reconfigured on the liquid crystal panel 5B through respective transparent display windows WI, W2 and W3 (refer to FIG. 7). On the other hand, when the combination of 3 symbols reconfigured on the pay line L on the liquid crystal panel 5B corresponds to a winning combination according to various preset winning combinations (refer to FIG. 6), the allotment corresponding to the winning combination is multiplied by the preset multiple and then the result is paid to the player.

In addition, it is the same as the above in deciding the preset number of times and the preset multiple of the free game immediately after moving to the free game and in reporting the decided preset number of times and preset multiple through the performances on the liquid crystal panel 5B.

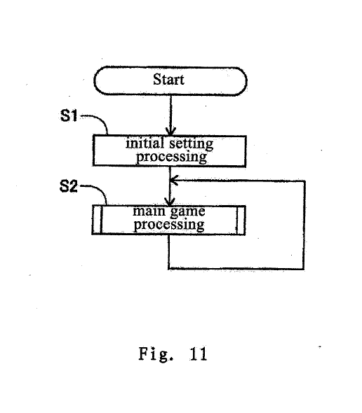

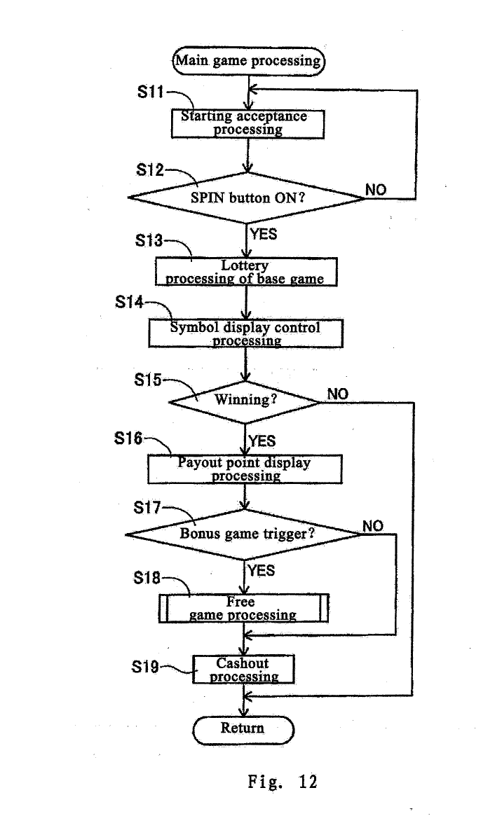

And then, a main control program executed in the gaming machine 1 of the present embodiment is illustrated with reference to the accompanied drawings. FIG. 11 is a flow chart of the main control program.

Firstly, when a power source switch is turned on (power on), the micro-computer 31 starts and executes an initial setting processing in Step 1 (S1). In the initial setting processing, the main CPU 32 executes the BIOS stored in the ROM 34, expands the compressed data installed in the BIOS in the RAM 33, executes the BIOS expanded in the RAM 33, diagnoses various peripheral devices and performs the initialization. Moreover, the main CPU 32 writes the game programs from the ROM 34 to the RAM 33 and obtains data for setting the payout ratio and country identification information. In addition, the main CPU 32 performs an authentication processing for programs while performing the initialization setting processing.

And then, in S2, the CPU 32 reads game programs sequentially from the RAM 33 and executes them to perform the main game processing. The games in the gaming machine 1 of the embodiment is performed by executing the main game processing. In addition, the main game processing is repeated when the power supply is provided to the gaming machine 1.

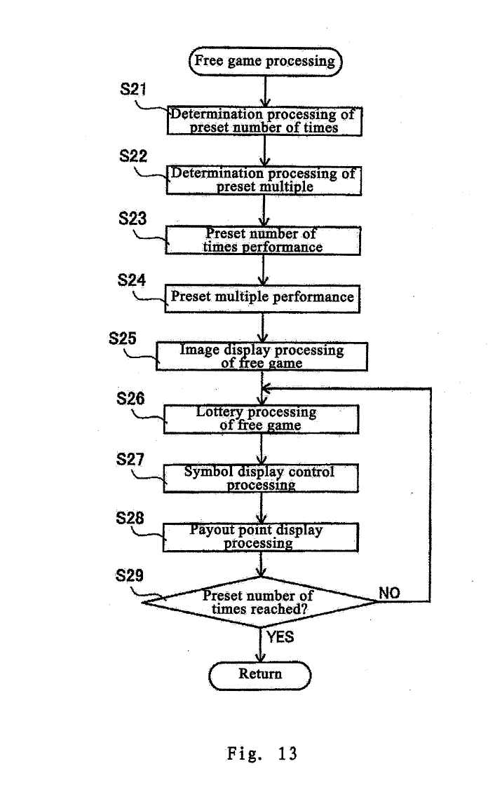

And then, a sub-processing of the main game processing of S2 is illustrated with reference to FIG. 12. FIG. 12 is a flow chart of a game processing program in the gaming machine 1 of the embodiment. In addition, programs represented by the flow chart in FIG. 12 are stored in the ROM 34 and RAM 33 of the gaming machine 1 and are executed by the CPU 32.

Firstly, as shown in FIG. 12, the main CPU 32 starts the acceptance processing in S11. During the acceptance processing, the player performs the insertion of coins or the bet operation by using the operation button 11 as the BET button. In addition, the main CPU 32 makes respective display windows W1, W2 and W3 on the liquid crystal panel 5B turn to a transparent status or sustain a transparent status by transmitting a control signal to the sub-control base board 72.

In S13, the main CPU 32 determines whether the operation button 11 as the SPIN button is pushed down. This determination is made according to a signal inputted to the main CPU 32 when the corresponding operation button 11 is pushed down. When the operation button 11 as the SPIN button is not pushed down (S12, NO), the process again returns to the acceptance processing (S11). And operation such as modifying the bet can be performed. On the other hand, when the operation button 11 as the SPIN button is pushed down (S12, YES), credits according to the above bet operation is subtracted from the credits of the player and is stored in the RAM 33 as the bet information.

And then, the main CPU 32 performs the lottery processing of the base game in S13. Specifically, the main CPU 32 selects random numbers corresponding to respective reels R1, R2 and R3 from the range of “0˜255” by executing the first lottery program included in the game programs. Then, code numbers of respective reels R1, R2 and R3 are decided according to the selected 3 random numbers with reference to the symbol weighting data corresponding to the data for setting the payout ratio. The main CPU 32 stores the decided code numbers of respective reels R1, R2 and R3 in the RAM 33 and then the process proceeds to S14. In addition, the credits obtained after the subtraction are also stored in the RAM 33 as the credit information.

Here the code numbers of respective reels R1, R2 and R3 correspond to the symbol numbers ( symbol numbers in FIG. 3) reconfigured on the pay line L on the liquid crystal panel 5B. Therefore, the main CPU 32 decides the symbol combination in the game by deciding the code numbers of respective reels R1, R2 and R3. For example, when the code numbers of respective reels R1, R2 and R3 are decided as “21”, “22” and “23”, the main CPU 32 decides a symbol combination constituted by 3 symbols of “FRANKENSTEIN” (refer to FIG. 3). Thus, the lottery of symbol combination in the base game is performed by deciding the code numbers of respective reels R1, R2 and R3.

Then the main CPU 32 performs the symbol display control processing in S14. Specifically, the main CPU 32 first performs the reel rotation processing, i.e. the main CPU 32 drives respective motors M1, M2 and M3 through the motor driving circuit 52 to make respective reels R1, R2 and R3 to rotate. Then, the main CPU 32 sends the command to the sub-control base board 72 etc. according to the performance form of the unit game (forms of image display on the liquid crystal panel 5B and of voice output from the speaker 23) to begin the performance with the decided performance pattern. When the preset time of stopping the rotation of respective reels R1, R2 and R3 comes, the main CPU 32 performs the reel stop processing and makes respective reels R1, R2 and R3 stop through the control of the motor driving circuit 52 according to the code numbers stored in the RAM 33. Thus, the symbol combination decided in S13 is reconfigured on the pay line L on the liquid crystal panel 5B.

Then, in S15, the main CPU 32 determines whether it is a winning combination according to the code numbers of respective reels R1, R2 and R3 stored in the RAM 33. If it is not the winning combination (S15: NO), the program is repeated; otherwise, if it is the winning combination (S15: YES), the process proceeds to S16.

In S16, the main CPU 32 performs the payout point display processing. Specifically, the main CPU 32 computes the allotment obtained by multiplying the bet by the allotment corresponding to the winning combination reconfigured on the pay line L on the liquid crystal panel 5B. Moreover, the computation is performed according to the bet information in the RAM 33 and the allotment table in FIG. 6. The computation result is stored in the RAM 33 as the pay information. Then, the main CPU 32 makes the payout point display portion 8 on the liquid crystal panel 5B display the pay information (the computation result) stored in the RAM 33 by sending a control signal to the display portion driving circuit 67.

In S17, the main CPU 32 determines whether the bonus game trigger is generated. Specifically, if three symbols of “FRANKENSTEIN” are reconfigured on the pay line L on the liquid crystal panel 5B, it is determined that the bonus game trigger is generated. In addition, the determination is also made according to the code numbers of respective reels R1, R2 and R3 stored in the RAM 33. When the bonus game trigger is generated (S17: YES), the main CPU 32 makes respective display windows on the liquid crystal panel 5B move to the opaque status by sending a control signal to the sub-control base board 72 and makes the liquid crystal panel 5B display the title image of the free game (refer to the upper-right in FIG. 1) so that the free game processing is performed in S18. The detailed free game processing will be illustrated in the following.

When the bonus game trigger is not generated (S17: NO), the main CPU 32 performs the cashout processing in S19. In this cashout processing, the main CPU 32 pays the allotments obtained in the base game and the free game respectively to the player according to the pay information in the RAM 33.

When performing the pay, the CPU 32 adds the credits stored as the credit information in the RAM 33 and the credits stored as the pay information (allotments obtained by the player in the base game and the free game respectively) in the RAM 33 and writes the adding result to the RAM 33 as the credit information. Then the main CPU 32 makes the credit point display portion 9 on the liquid crystal panel 5B display the credit information (the adding result in S19) stored in the RAM 33 by sending a control signal to the display portion driving circuit 67. At the same time, the main CPU 32 rewrites “0” in the RAM 33 as the pay information and sends a control signal to the display portion driving circuit 67 to make the payout point display portion 8 on the liquid crystal panel 5B display “0”.

In addition, in the cashout processing, the credits of the player can be paid in the form of the corresponding coins (one credit equals to one coin) or can be paid in the form of the ticket with a bar code printed by the ticket printer 14 when the player pushes down the operation button 11 as the CASHOUT button.

Then the main CPU 32 performs the main game processing again after the cashout processing in S19.

The sub-processing of the free game processing in S18 will be illustrated with reference to FIG. 13. FIG. 13 is a flow chart of a sub-processing program of a free game processing in the gaming machine 1 according to the present embodiment. In addition, programs shown in FIG. 13 are stored in the ROM 34 and RAM 33 in the gaming machine 1 and are executed by the main CPU 32.

In the free game processing in S18, as shown in FIG. 13, the main CPU 32 performs the determination processing of the preset number of times in S21. Specifically, the main CPU 32 selects random numbers from the range of “0˜255” by executing the second lottery program included in the game programs. Then, serial numbers of the preset number of times are decided according to the symbol weighting data corresponding to the data for setting the payout ratio. The main CPU 32 stores the decided serial numbers of the number of times in the RAM 33 and then the process proceeds to S22.

In S22, the main CPU 32 performs the determination processing of the preset multiple. Specifically, the main CPU 32 selects random numbers from the range of “0˜255” by executing the third lottery program included in the game programs. Then, serial numbers of the preset multiples are decided according to the symbol weighting data corresponding to the data for setting the payout ratio. The main CPU 32 stores the decided serial numbers of the preset multiples in the RAM 33 and then the step enters S22.

In S23, the main CPU 32 performs the preset number of times performance. Specifically, the main CPU 32 performs the preset number of times performance shown in FIG. 9 on the liquid crystal panel 5B by sending a control signal to the sub-control base board 72. At this time, the value corresponding to the serial number stored in the RAM 33 is amplified and displayed (refer to the lower portion in FIG. 9).

In S24, the main CPU 32 performs the preset multiple performance. Specifically, the main CPU 32 performs the preset multiple performance shown in FIG. 9 on the liquid crystal panel 5B by sending a control signal to the sub-control base board 72. At this time, the expression corresponding to the serial number of the multiple stored in the RAM 33 is amplified and displayed (refer to the lower-right in FIG. 10).

In S25, the main CPU 32 performs the image display processing of the free game image. Specifically, the main CPU 32 makes the liquid crystal panel 5B return to the display status before moving to the free game (refer to the lower-left in FIG. 1), i.e. make the pay line L displayed on the liquid crystal panel 5B again by sending a control signal to the sub-control base board 72. In addition, since three display windows W1, W2 and W3 become transparent once again, the player can see respective reels R1, R2 and R3 again.

In S26, the main CPU 32 performs the lottery processing of the free game. Specifically, the main CPU 32 selects random numbers corresponding to respective reels R1, R2 and R3 from the range of “0˜255” by executing the first lottery program included in the game programs. Then, code numbers of respective reels R1, R3 and R3 are decided according to the selected 3 random numbers with reference to the symbol weighting data corresponding to the data for setting the payout ratio. The main CPU 32 stores the decided code numbers of respective reels R1, R2 and R3 in the RAM 33 and then the process proceeds to S27.

Here the code numbers of respective reels R1, R2 and R3 correspond to the symbol numbers of the symbol combination (symbol numbers in FIG. 3) reconfigured on the pay line L on the liquid crystal panel 5B. Therefore, the main CPU 32 decides the symbol combination in the game by deciding the code numbers of respective reels R1, R2 and R3. For example, when the code numbers of respective reels R1, R2 and R3 are decided as “13”, “08” and “07”, the main CPU 32 decides a symbol combination constituted by 3 symbols of “BLUE 7” (refer to FIG. 3). Thus, the lottery of symbol combination in the free game is performed by deciding the code numbers of respective reels R1, R2 and R3.

Then the main CPU 32 performs the symbol display control processing in S27. Specifically, the main CPU 32 first performs the reel rotation processing, i.e. the main CPU 32 drives respective motors M1, M2 and M3 through the motor driving circuit 52 to make respective reels R1, R2 and R3 to rotate. Then, the main CPU 32 sends the command to the sub-control base board 72 etc. according to the performance form of the unit game (forms of image display on the liquid crystal panel 5B and of voice output from the speaker 23) to begin the performance with the decided performance pattern. When the preset time of stopping the rotation of respective reels R1, R2 and R3 comes, the main CPU 32 performs the reel stop processing and makes respective reels R1, R2 and R3 stop through the control of the motor driving circuit 52 according to the code numbers stored in the RAM 33. Thus, the symbol combination decided in S26 is reconfigured on the pay line L on the liquid crystal panel 5B.

In S28, the main CPU 32 performs the payout point display processing. Specifically, the main CPU 32 computes the allotment obtained by multiplying the preset multiple by the allotment corresponding to the winning combination reconfigured on the pay line L on the liquid crystal panel 5B. Moreover, the computation is performed according to the serial number of the multiple in the RAM 33 and the allotment table in FIG. 6. The computation result is added to the pay information in the RAM 33 and then the adding result is stored in the RAM 33. Then, the main CPU 32 makes the payout point display portion 8 on the liquid crystal panel 5B display the pay information (the adding result) stored in the RAM 33 by sending a control signal to the sub-control base board 72.

In S29, the main CPU 32 determines whether the unit game is repeated for the preset number of times. In order to perform the determination, for example, the variable in RAM 33 is set to “0” when moving to the free game, increased each time when perform the processing in S29 and compared with the preset number of times. In addition, the preset number of times is determined according to the serial number stored in the RAM 33. When the unit game is not performed for the preset number of times (S29: NO), the process returns to the lottery processing of the free game (S26) and then the next unit game is executed. On the other hand, when the unit game is performed for the preset number of times (S29: YES), the free game processing ends and the process returns to the main game processing in FIG. 12.

As illustrated above, the base game executed in the gaming machine 1 of the embodiment takes a series of processing (S13, S14, S15) including the symbol display control processing (S14) as the unit game and the symbol display control processing (S14) performs a processing from the variably displayed of symbols to the stop and display of symbols through respective display windows W1, W2 and W3 on the liquid crystal panel 5B (refer to FIG. 12). In the base game, when an combination of 3 symbols of “FRANKENSTEIN” (bonus game trigger) (S16:YES) is reconfigured on the pay line L on the liquid crystal panel 5B, the free game as one of the bonus games is performed (refer to FIG. 13).

In the free game, the unit game consists of a series of processing (S26˜S28) including the symbol display control processing (S27) and the symbol display control processing (S27) performs the variably display of symbols to the stop and display of symbols through respective display windows W1, W2 and W3 on the liquid crystal panel 5B, to execute the unit game for the preset number of times (S29) and increases the allotment based on the execution result by the preset multiple (S28).

In addition, when moving from the base game to the free game and before executing the first unit game of the free game, the determination processing of the preset number of times for deciding the preset number of times from the set of preset number of times (values of “25”, “20”, “15”, “10”) (S21) and the determination processing of the preset multiple for deciding the preset mutiple from the set of preset multiples (expressions of “×5”, “×4”, “×3”, “×2” ) (S22) are performed. In addition, the decided preset number of times and preset multiple in the determination processing are reported through respective performances executed on the liquid crystal panel 5B (S23, S24).

Therefore, the player has the excitation to determine the preset number of times for repeating the unit game of the free game according to respective values of “25”, “20”, “15”, “10” and to determine the preset multiple in increasing the allotment in each unit game of the free game according to respective expressions of “×5” , “×4” , “×3”, “×2” In addition, the excitation of the player may be sustained until the end of performances by performing respective performances for reporting the results of these determinations on the liquid crystal panel 5B.

In addition, when the preset number of times for repeating the unit game of the free game is determined with a smaller value or when the preset multiple to increase the allotment is determined with a smaller expression, the payout rate may be reduced but since the preset number of times and the preset multiple of the free game are determined by the payout ratio (S21, S22), the payout ratio can be easily adjusted when determining the preset number of times and the preset multiple of the free game later.

In addition, the preset number of times performance that is executed on the liquid crystal panel 5B immediately after moving to the free game reports the preset number of times determined during the determination processing of the preset number of times (S21) through the liquid crystal panel 5B. During the preset number of times performance, as shown in FIG. 9, the symbol of FRANKENSTEIN constituting the bonus game trigger in the base game and the set of preset number of times (values of “25”, “20”, “15”, “10”) are displayed on the liquid crystal panel 5B. Since the reporting process is displayed that the FRANKENSTEIN selects the determined number of times from the values of “25”, “20”, “15”, “10”, the player is interested in the performance and the excitation of the player can be further increased.

In addition, the preset multiple performance that is executed on the liquid crystal panel 5B immediately after moving to the free game reports the preset multiple determined during the determination processing of the preset multiple (S22) through the liquid crystal panel 5B. During the preset multiple performance, as shown in FIG. 10, the symbol of “FRANKENSTEIN” constituting the bonus game trigger in the base game and the set of preset multiples (expressions of “×5”, “×4”, “×3”, “×2”) are displayed on the liquid crystal panel 5B. Since the reporting process is displayed that the “FRANKENSTEIN” selects the determined multiple from the expressions of “×5”, “×4”, “×3”, “×2” , the player is interested in the performance and the excitation of the player can be further increased.

In addition, for the preset number of times performance (refer to FIG. 9) and the preset multiple performance (refer to FIG. 10) executed on the liquid crystal panel 5B immediately after moving to the free game, after the preset number of times performance is performed on the liquid crystal panel 5B (refer to FIG. 9) (S23), the preset multiple performance is performed on the liquid crystal panel 5B (refer to FIG. 10) (S24). Therefore the player is interested in the performance and the excitation of the player can be further sustained.

During the preset number of times performance immediately performed on the liquid crystal panel 5B after moving to the free game, as shown in the upper and middle portions of FIG. 9, in the long corridor along which the “FRANKENSTEIN” carrying the bag escapes, multiple rectangle areas representing values of preset number of times “25”, “20”, “15”, “10” rotate slowly in the vertical direction in a mode visible to the player. Therefore, the player may reliably recognize that values can be the preset number of times are

In addition, during the preset multiple performance immediately performed on the liquid crystal panel 5B after moving to the free game, as shown in the upper, middle and lower portions of FIG. 10, each expression of “×5”, “×4”, “×3”, “×2” which can be the preset multiple rotates from up to down slowly in a visible mode to the player in the bag carried by the “FRANKENSTEIN”. Therefore, the player may reliably recognize that expressions can be the preset multiple are “×5”, “×4”, “×3”, “×2”.

In addition, the present invention is not limited to the above embodiments and may have various modifications without departing from the spirit of the present invention.

For example, for the preset number of times performance (refer to FIG. 9) and the preset multiple performance (refer to FIG. 10) on the liquid crystal panel 5B immediately after moving to the free game (S23, S24), the order of the two kinds of performances can be reversed and may be displayed on the liquid crystal panel 5A which is not for displaying the game execution status or may be displayed simultaneously on the liquid crystal panel 5A and 5B.

In addition, the preset multiple of the free game may be fixed in advance and the processing of determination and performance is only aimed at the preset number of times of the free game (S21, S23).

On the other hand, the preset number of times may be fixed in advance and the processing of determination and performance is only aimed at the preset multiple of the free game (S22, S24).

In addition, the gaming machine 1 of the embodiment is a slot machine which executes the slot game with 3 mechanical reels. However, a slot machine that executes the slot game with 5 reels or 9 reels can be also used. Moreover, it can be a slot machine of video reels.

In addition, in the gaming machine according to the embodiment, there is one pay line L. However, there may be a plurality of pay lines L. In this case, in the base game (slot game), generally the number of effective ones of all pay lines L is set together with the bet. However, the case may also be that the number of effective pay lines L is set and then the bet is set, or the number of effective pay lines L is set after the bet is set.

### INDUSTRIAL AVAILABILITY

The present invention may be applied to a technology deciding attribute items of a bonus game in a gaming machine.

1. A gaming machine, comprising:
a display, displaying a plurality of symbols; and
a control apparatus, programmed by operating the display according to the following modes (a)˜(e), wherein
the control apparatus
(a) executes a base game, wherein the base game from a variable display of symbols on the display to a stop and display of the symbols is taken as a unit game;
(b) executes a bonus game, in which the unit game is executed for a preset number of times;
(c) selects the preset number of times from a set of preset number of times before executing the unit game in the bonus game;
(d) reports the selection result through the display; and
(e) ends the bonus game when the unit game has been executed for the preset number of times.

2. The gaming machine according to claim 1, wherein
when executing the operation in the mode (d), the control apparatus
(1) displays a character related to the base game and the set of preset number of times on the display; and
(2) executes on the display a performance in which the character selects the preset number of times from the set of preset number of times.

3. A gaming machine, comprising:
a display, displaying a plurality of symbols; and
a control apparatus, programmed by operating the display according to the following modes (a)˜(e), wherein
the control apparatus
(a) executes a base game, wherein a process from a variable display of the symbols on the display to a stop and display of symbols is taken as a unit game;
(b) executes a bonus game, in which the unit game is executed for a preset number of times and an allotment based on the execution result is increased by a preset multiple;
(c) selects the preset multiple from a set of the preset multiple before executing the unit game in the bonus game;
(d) reports the selection result through the display; and
(e) ends the bonus game when the unit game has been executed for the preset number of times with the preset multiple.

4. The gaming machine according to claim 3, wherein
when executing the operations in the mode (d), the control apparatus
(1) displays a character related to the base game and the set of preset multiples on the display; and
(2) executes on the display a performance in which the character selects the preset multiple from the set of preset multiples.

5. A gaming machine, comprising:
a display, displaying a plurality of symbols; and
a control apparatus, programmed by operating the display according to the following modes (a)˜(e), wherein
the control apparatus
(a) executes a base game, wherein a process from a variable display of the symbols on the display to a stop and display of symbols is taken as a unit game;
(b) executes a bonus game, in which the unit game is executed for a preset number of times and an allotment based on the execution result is increased by a preset multiple;
(c) performs a first selection to select the preset number of times from a set of preset number of times and performs a second selection to select the preset multiple from a set of the preset multiple before executing the unit game in the bonus game;
(d) reports the selection results of the first selection and the second selection through the display; and
(e) ends the bonus game when the unit game has been executed for the preset number of times with the preset multiple.

6. The gaming machine according to claim 5, wherein
when executing the operation in the mode (d), the control apparatus
(1) display a character related to the base game, the set of preset number of times and the set of preset multiples on the display; and
(2) executes on the display a first performance in which the character selects the preset number of times from the set of preset number of times and a second performance in which the character selects the preset multiple from the set of preset multiples.

7. The gaming machine according to claim 6, wherein when executing the operation in the mode (d) (2), the control apparatus executes the second performance on the display after the first performance is executed on the display.

8. The gaming machine according to claim 6, wherein when executing the operation in the mode (d) (2), the control apparatus executes the first performance on the display after the second performance is executed on the display.
